(19) United States
(12) Patent Application Publication
(10) Pub. No.: US 2012/0234820 A1
(43) Pub. Date: Sep. 20, 2012

(54) Heater for fusing apparatus and fusing apparatus and image forming apparatus having the same

(75) Inventors: Jong-oh Kim, Seongnam-si (KR); Hae-seog Jo, Yongin-si (KR)

(73) Assignee: SAMSUNG ELECTRONICS CO., LTD., Suwon-si (KR)

(21) Appl. No.: 13/137,940

(22) Filed: Sep. 21, 2011

(30) Foreign Application Priority Data
Mar. 16, 2011 (KR) 10-2011-0023498

(51) Int. Cl. H05B 3/00; G03G 15/20

(52) U.S. Cl. 219/216; 399/328

(57) ABSTRACT

A heater for a fusing apparatus that is used in an image forming apparatus includes a carbon fiber filament; a holding pipe which receives the carbon fiber filament; and terminals which are disposed opposite ends of the holding pipe and connects the carbon fiber strands with an electric power source. The carbon fiber filament may be formed of any of one to seven carbon fiber strands and each of the carbon fiber strands may have linear density of any of 1-70 tex.

### CROSS-REFERENCE TO RELATED APPLICATIONS

This application claims priority under 35 U.S.C. §119(a) from Korean Patent Application No. 10-2011-0023498 filed Mar. 16, 2011 in the Korean Intellectual Property Office, the disclosure of which is incorporated herein by reference in its entirety.

### BACKGROUND

1. Field

The present disclosure relates to an image forming apparatus. More particularly, the present disclosure relates to a heater for a fixing apparatus being usable for an image forming apparatus.

2. Description of the Related Art

Image forming apparatuses, such as printers, facsimile machines, copy machines, multifunctional products, or the like, use an electro photographic method to form an image on a printing medium. In order to form an image on the printing medium, the image forming apparatus generally performs a charging process, an exposing process, a developing process, a transferring process, and a fusing process.

A fusing apparatus that is used during the fusing process applies heat and pressure to the printing medium to fuse developer onto the printing medium. The fusing apparatus is generally configured of a heat unit and a pressure unit. The heat unit and the pressure unit include a heat member and a pressure member which rotate in contact with each other. A fusing nip is formed between the heat member and the pressure member. While the printing medium passes through the fusing nip, the heat and pressure are transferred to the printing medium so that developer is fused on the printing medium.

For generating heat that is transferred to the printing medium, a heating element, namely a heater is arranged inside the heat member. Halogen lamps are mainly used as the heater for the fusing apparatus. The halogen lamp uses a tungsten filament and the tungsten filament has a fairly low electric resistance at the room temperature. Accordingly, when an electric power is provided to the halogen lamp, an excessive inrush current is generated from when the electric power is supplied for a certain period of time. The excessive inrush current may generate a radical voltage change and a flicker phenomenon so as to deteriorate printing quality of the image forming apparatus.

One of performances that are required to the image forming apparatus is a fast first paper out time (hereinafter, refers to FPOT). It is desirable to increase a heat energy that the heater inside the heat unit generates for a fast FPOT. For this it is desirable to use a halogen lamp having a large heating quantity. However, halogen lamps of 850 W or more are currently not circulating the market.

For increasing the heating capacity of the halogen lamp, two halogen lamps may be disposed inside the heat unit. However, this method causes the inrush current to be increased and hinders in miniaturizing the fusing apparatus. The image forming apparatus is gradually miniaturized according to customer needs, and so the fusing apparatus is also gradually miniaturized. As a result, it is difficult to allow the fusing apparatus to have a space inside which a plurality of halogen lamps is disposed. To use two halogen lamps or more also increases a manufacturing cost of the image forming apparatus.

Therefore, there is a need to develop a heater for a fusing apparatus that can allow an inrush current of the fusing apparatus to be prevented, can allow the fusing apparatus to be miniaturized, and can allow a manufacturing cost of the fusing apparatus to be reduced.

### SUMMARY

The present disclosure has been developed in order to overcome the above drawbacks and other problems associated with the conventional arrangement. An aspect of the present disclosure is to provide a heater for a fusing apparatus that can prevent an inrush current of the fusing apparatus, can be miniaturized, and can reduce a manufacturing cost thereof and a fusing apparatus and an image forming apparatus having the same.

The above aspect and/or other feature of the present disclosure can substantially be achieved by providing a heater for a fusing apparatus that is used in an image forming apparatus, which may include a carbon fiber filament; a holding pipe which receives the carbon fiber filament; and terminals which are disposed opposite ends of the holding pipe and connects the carbon fiber strands with an electric power source. The carbon fiber filament may be formed of any of one to seven carbon fiber strands and each of the carbon fiber strands may have linear density of any of 1-70 tex.

The carbon fiber filament may be formed of the carbon fiber strand of any of 20-40 tex.

The carbon fiber strand may be composed of 1100 or less carbon fiber yarns.

The heater may have an output of 700 W-3000 W, and the carbon fiber filament may have weight of 0.86 g or less.

The carbon fiber filament may have weight per unit length of 4 mg/mm or less.

The carbon fiber filament may include metal contents and carbon content of 50% or more.

The carbon fiber filament may be formed in a spiral shape, and the spiral has an inner diameter of 8 mm or less.

The carbon fiber filament may include heat capacity of 1.4 J/° C. or less.

The holding pipe may have an inner diameter of 10 mm or less and a thickness of 1.0 mm or less.

In accordance with an aspect of another exemplary embodiment, a heater for a fusing apparatus that is used in an image forming apparatus is provided, which may include a carbon fiber filament; a holding pipe which receives the carbon fiber filament; and terminals which are disposed opposite ends of the holding pipe and connects the carbon fiber strands with an electric power source; wherein the carbon fiber filament is formed of any of 1-70 tex carbon fiber strands, and wherein when rated voltage applying to the carbon fiber filament is in a range of 200-250 V, electric resistance of opposite ends of the carbon fiber filament is in a range of 5-100Ω.

In accordance with an aspect of another exemplary embodiment, a heater for a fusing apparatus that is used in an image forming apparatus is provided, which may include a carbon fiber filament; a holding pipe which receives the carbon fiber filament; and terminals which are disposed opposite ends of the holding pipe and connects the carbon fiber strands with an electric power source; wherein the carbon fiber filament is formed of any of 1-70 tex carbon fiber strands, and wherein when rated voltage applying to the carbon fiber filament is in a range of 90-130 V, electric resistance of opposite ends of the carbon fiber filament is in a range of 2-50Ω.

When electric power is supplied to the carbon fiber filament, a maximum temperature of the carbon fiber filament may be 1500° C. or more.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and/or other aspects and advantages of the inventive concept will become apparent and more readily appreciated from the following description of the exemplary embodiments, taken in conjunction with the accompanying drawings in which:

FIG. 1 is a sectional view schematically illustrating an image forming apparatus according to an exemplary embodiment;

FIG. 2 is a partially sectional perspective view schematically illustrating a fusing apparatus according to an exemplary embodiment;

FIG. 3 is an enlarged perspective view illustrating a heater for a fusing apparatus according to an exemplary embodiment;

FIG. 4 is a partially perspective view illustrating a portion of a carbon fiber filament used in a heater for a fusing apparatus according to an exemplary embodiment;

FIG. 5 is a partially enlarged perspective view magnifying 200 times a carbon fiber filament into which seven 40 tex carbon fiber strands are twisted and that is used in a heater for a fusing apparatus according to an exemplary embodiment;

FIG. 6 is a graph illustrating a change of electric power consumption according to time of a conventional fusing apparatus having two tungsten lamps;

FIG. 7 is a graph illustrating a property change of a tungsten lamp according to time;

FIG. 8 is a graph illustrating property changes of a tungsten lamp and a conventional carbon fiber filament heater according to time;

FIG. 9 is a graph illustrating a temperature change according to time of a heater that uses a carbon fiber filament made of seven 40 tex carbon fiber strands;

FIG. 10 is a graph illustrating an electric resistance change and a current change according to time of a heater that uses a carbon fiber filament made of seven 40 tex carbon fiber strands;

FIG. 11 is a graph illustrating a temperature change according to time of three heat rollers which use a carbon fiber filament having a different heat capacity, respectively;

FIG. 12 is a graph comparing temperature rising performance of a heater according to an exemplary embodiment with that of a conventional tungsten lamp;

FIG. 13 is a graph illustrating temperature rising performances of carbon fiber filaments having different inner diameters and a tungsten lamp; and

FIG. 14 is a graph illustrating electric power consumptions of fusing apparatuses that use a heater according to an exemplary embodiment and conventional tungsten lamps.

Throughout the drawings, like reference numerals will be understood to refer to like parts, components and structures.

### DETAILED DESCRIPTION

Hereinafter, certain exemplary embodiments of the present disclosure will be described in detail with reference to the accompanying drawings.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

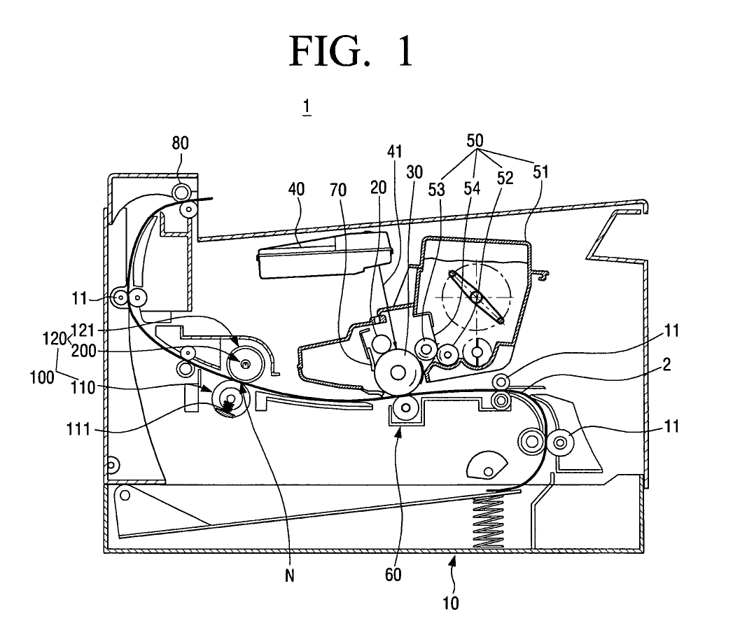

FIG. 1 is a sectional view schematically illustrating an image forming apparatus 1 according to an exemplary embodiment. The image forming apparatus 1 is an apparatus that forms a predetermined image on a printing medium using an electro photographic method, and may include apparatus such as laser printers, facsimile machines, copy machines, multifunctional products, or the like.

Referring to FIG. 1, an image forming apparatus 1 according to an exemplary embodiment may include a paper feeding apparatus 10, a charging apparatus 20, an exposure apparatus 40, a developing apparatus 50, a transferring apparatus 60, a fusing apparatus 100, and a paper discharging apparatus 80.

The paper feeding apparatus 10 stores a certain sheets of printing media and picks up the printing media one by one to be supplied. The printing medium is moved along a moving passage 2 by transfer rollers 11.

The charging apparatus 20 charges a photosensitive medium 30 with a predetermined potential. The exposure apparatus 40 scans a light 41 onto the photosensitive medium 30 to form an electrostatic latent image corresponding to a printing data on a surface of the photosensitive medium 30.

The developing apparatus 50 supplies developer to the photosensitive medium 30 on which the electrostatic latent image is formed so as to form a developer image. The developing apparatus 50 may include a developer receiving portion 51, a developer supplying roller 52, a developing roller 53, and a regulating blade 54.

The developer receiving portion 51 accommodates a predetermined amount of developer therein. The developer supplying roller 52 supplies the developing roller 53 with the developer that is accommodated in the developer receiving portion 51, thereby forming a developer layer on the developing roller 53. When the developing roller 53 rotates, the regulating blade 54 regulates the developer layer formed on the developing roller 53 into a predetermined height and charges the developer. The developer forming the developer layer on a surface of the developing roller 53 is moved onto the electrostatic latent image formed on the photosensitive medium 30 due to a potential difference, thereby forming a developer image.

The transferring apparatus 60 transfers the developer image formed on the photosensitive medium 30 onto the printing medium. A cleaning apparatus 70 removes a waste developer remaining on the surface of the photosensitive medium 30 after the transfer process is performed.

The fusing apparatus 100 applies heat and pressure onto the printing medium, thereby fusing the developer that forms the developer image on the printing medium. After the printing medium on which the developer is fused is discharged outside the image forming apparatus 1 by the paper discharging apparatus 80, a printing process of the image forming apparatus 1 is completed.

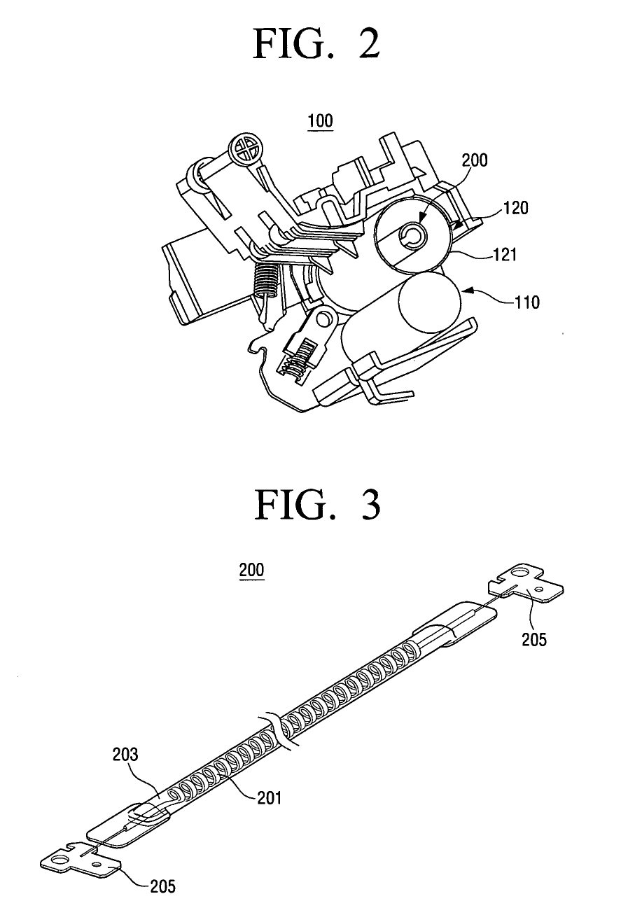

Referring to FIGS. 1 and 2, the fusing apparatus 100 according to an exemplary embodiment may include a pressure member 110 and a heat member 120. A fusing nip N is formed in an area where the pressure member 110 contacts the heat member 120. There is an unfused developer image on the printing medium having passed through the transferring apparatus 60. Thus while the printing medium is passing through the fusing nip N, heat and pressure are applied to the printing medium so that the unfused developer is fused onto the printing medium.

The pressure member 110 is pressed toward the heat member 120 by an elastic member 111, thereby applying pressure to the printing medium passing through the fusing nip N. In this embodiment, the pressure member 110 is configured as a roller type, but the pressure member 110 may be configured as a belt type. Since those of ordinary skill in the art can easily know the pressure member of the belt type from known techniques, detailed explanations thereof will be omitted.

The heat member 120 applies heat to the printing medium passing through the fusing nip N and may include a heat roller 121 and a heater 200 that is disposed inside the heat roller 121. The heater 200 generates heat for supplying to the printing medium and the heat generated by the heater 200 is transmitted to the printing medium via the heat roller 121. Since the heat roller 121 is heated to a high temperature by the heater 200, it is desirable that the heater 200 is made of heat-resistant materials. In this embodiment, the pressure member 110 is configured as a roller type using the heat roller 121, but the heat member 120 can be configured as a belt type. The belt type uses a heat belt instead of the heat roller 121. Since the heat member of the belt type can be easily understood from the known techniques by those of ordinary skill, detailed explanation thereof will be omitted.

Hereinafter, the heater 200 for a fusing apparatus according to an exemplary embodiment will be explained with reference to FIGS. 3 to 14.

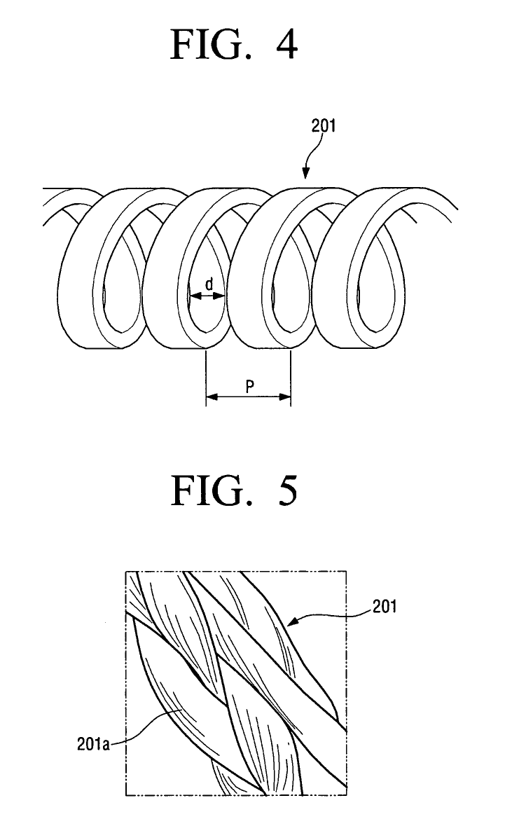

FIG. 3 is an enlarged perspective view illustrating the heater 200 for a fusing apparatus according to an exemplary embodiment and FIG. 4 is a partially perspective view illustrating a portion of a carbon fiber filament 201 that is used in the heater 200 for a fusing apparatus of FIG. 3.

Referring to FIG. 3, the heater 200 for a fusing apparatus includes a holding pipe 203, a carbon fiber filament 201 and terminals 205.

The holding pipe 203 has substantially a cylinder shape. An inert gas such as argon is hermetically sealed inside the holding pipe 203. The holding pipe 203 may be formed of a transparent and heat-resistant material. For example, the holding pipe 203 may be formed of a quartz glass. For miniaturizing the heat roller 121 it is desirable that the holding pipe 203 is formed to have an outer diameter of 10 mm or less. For example, the holding pipe 203 may have an outer diameter of 8 mm or 6 mm. The minimum outer diameter of the holding pipe 203 may be determined by a size of the carbon fiber filament 201 that is received inside the holding pipe 203.

The carbon fiber filament 201 is disposed inside the holding pipe 203 and converts an electric energy supplied from an outer electric power source into heat. The terminals 205 are disposed on opposite ends of the holding pipe 203 to supply electric power to the carbon fiber filament 201. The terminals 205 are electrically connected with the opposite ends of the carbon fiber filament 201. Therefore, when the electric power is supplied to the terminals 205 disposed on the opposite ends of the holding pipe 203, the carbon fiber filament 201, which is disposed inside the holding pipe 203, generates heat.

The carbon fiber filament 201 is used instead of a tungsten filament that is used in the halogen lamp which a conventional fusing apparatus uses. The tungsten filament is widely used as a heat source for a fusing apparatus because the tungsten filament allows temperature thereof to rise above 2000° C., has an excellent heating efficiency, and has a small over-shoot.

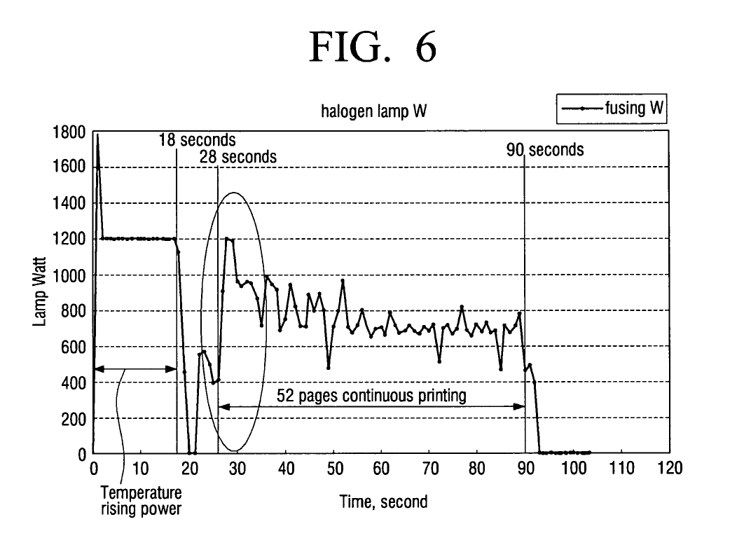

For a high-speed printing operation, it is desirable to heat the heat member to the temperature at which the heat member can fuse developer within a short time. For this, it is desirable for a heat source of the heat member to have sufficient electric power consumption W. For example, when an image forming apparatus having a fusing apparatus in which a halogen lamp using a tungsten filament is disposed performs a printing operation at a speed of 48 PPM, as illustrated in FIG. 6, in the early part of the printing operation the fusing apparatus consumes electric power of approximately 1200 W. Therefore if the fusing apparatus does not use the heat source having the electric power consumption above 1200 W, developer may not be fused on the printing medium. Hereinafter, the halogen lamp is referred as a tungsten lamp for convenience of explanation, but the halogen lamp may be also used if necessary.

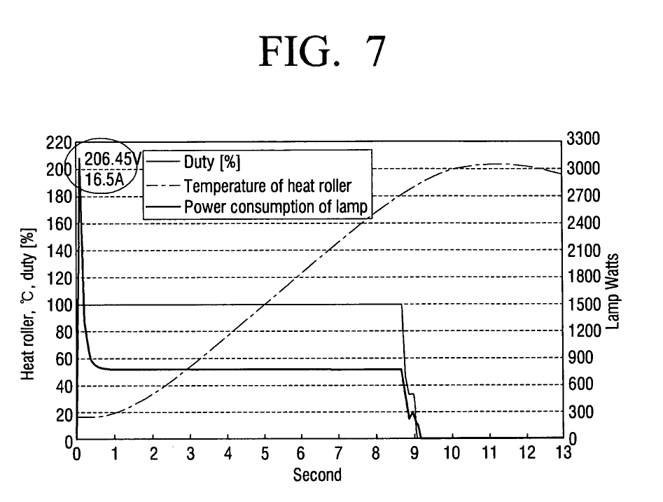

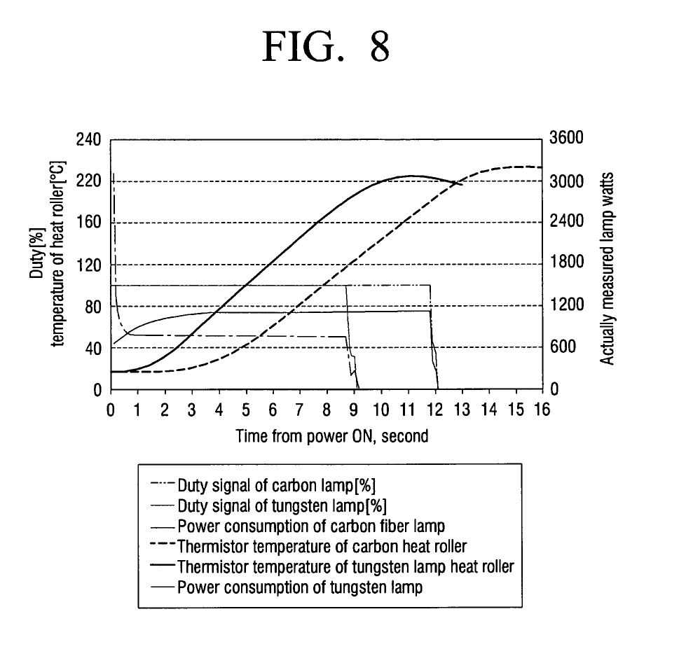

The tungsten filaments having the electric power consumption of 850 W or less are generally distributed in the market. As a result, when high electric power consumption is required for a high speed printing, two tungsten lamps of 850 W are generally used. It is difficult that a dual tungsten lamp using two tungsten lamps is used as a fusing heat source because as illustrated in FIG. 7, a high inrush current and a flicker phenomenon occur. Therefore, for solving this problem, special controlling methods such as a zero crossing phase control, a chopping control, or the like are used.

Therefore the carbon fiber filament 201 should satisfy the condition in order to be used as a heat source of the fusing apparatus 100. Generally a plurality of carbon fiber strands is twisted to form the carbon fiber filament 201 as illustrated in FIG. 5. FIG. 5 illustrates the carbon fiber filament 201 that seven carbon fiber strands 201a of 40 tex are twisted to form. A carbon fiber strand 201a may be made of 1100 carbon fiber yarns or less. Also, the carbon fiber yarn consisting of the carbon fiber filament may include metal contents and carbon content of 50% or more.

The carbon fiber filament that is commercially available is made of twisted seven carbon fiber strands or more with a leaner density of the range of approximately 100 tex-200 tex. The tex is a unit of measure for the linear mass density of fibers and is defined as the mass in grams per 1000 meters. That is, one tex is 1 g/1000 m=1 mg/m.

The conventional carbon fiber filament does not generate the inrush current but it takes a long time for the conventional carbon fiber filament to rise up to a predetermined temperature. Therefore, the conventional carbon fiber filament has a delay time and a heating efficiency lower than that of the tungsten filament.

Table 1 shows the results of a comparative test of a carbon fiber lamp using the conventional carbon fiber filament and a tungsten lamp using a tungsten filament. FIG. 8 illustrates the temperature rising performance of the conventional carbon fiber filament that is compared with that of the tungsten lamp of 850 W. The conventional carbon fiber filament which seven carbon fiber strands with the linear density of 100 tex are twisted into is used. The carbon fiber filament is formed in a coil shape as illustrated in FIGS. 3 and 4.

TABLE 1

| | | | Outer | | | | | | Time till |
|---|---|---|---|---|---|---|---|---|---|
| | | | diameter | Filament type | | | | Delay | maximum |
| | | Number | of | | Number | | | time | power |
| Lamp | Power | of | holding | | of | Inner | Turn | when | (approximately |
| type | consumption | lamps | pipe | thickness | strands | diameter | number | starting | 97.7%) |
| Unit | Watts | pieces | mm | Tex | pieces | mm | turns | Second | second |
| carbon | 1300 | 1 | 8 | 100 | 7 | 6 | 58 | 2.5 | 3.60 |
| fiber | | | | | | | | | |
| filament | | | | | | | | | |

| | | | | | | |
|---|---|---|---|---|---|---|
| tungsten | 850 | 1 | 6 | tungsten | 0.8 | Inrush 3200 W |
| filament | | | | | | |

| | | | | | | | | temperature | |
|---|---|---|---|---|---|---|---|---|---|
| | | | | | Lamp | % of Lamp | | rising | |
| | | | | temperature | energy | energy | | speed % | |
| | | | | rising | consumed | consumed | temperature | (based on | |
| | | Actually | | speed % | till | till | rising | 100 W) | |
| | | measured | temperature | (compared | temperature | temperature | speed | (compared | |
| Lamp | inrush | maximum | rising | to tungsten | reach from | reach from | (based on | to tungsten | Over |
| type | current | power | speed | filament) | 0 to 180° C. | 0 to 180° C. | 100 W) | filament) | shoot |
| unit | Watts | Watts | ° C./second | % | Whr | % | | % | |
| carbon | None | 1125 | 15.2 | 7.4 | 3.6 | 181 | 1.25 | 51 | 213 |
| fiber | | | | | | | | | |
| filament | | | | | | | | | |
| tungsten | 3115 | 771 | 20.6 | 100 | 1.99 | 100 | 2.67 | 100 | 204 |
| filament | | | | | | | | | |

In Table 1, the inner diameter and turn number represent an inner diameter d (see FIG. 4) and the turn number of the carbon fiber filament 201, respectively. Temperature of the filament is approximately in the range of 1100-1300° C.

Referring to FIG. 8, it is found that because the conventional carbon fiber filament is made of a lot of carbon fiber strands having a large tex, the carbon fiber filament has the delay time when temperature does not rise at early part longer than, the temperature rising speed slower than, and the energy consumption for heating up to the fusing temperature larger than the 850 W tungsten lamp. For example, if the energy that is consumed to heat the tungsten lamp to the fusing temperature is 100%, the energy that is consumed to heat the carbon fiber filament lamp to the fusing temperature is 181%.

For using the carbon fiber filament as a heat source of a fusing apparatus being used in the image forming apparatus that can perform a high speed printing, the carbon fiber filament is desirable to form one lamp that has the electric power consumption of the range of approximately 700 W-3000 W without the inrush current and flicker phenomenon.

The conventional carbon fiber filament lamp uses approximately 100 W-3000 W by one lamp. However, if the conventional carbon fiber filament is consisted of seven carbon fiber strands of 100 tex, when operating at 1200 W, the carbon fiber strands has high electric resistance of approximately 60-80Ω. Therefore, there is a delay time of approximately 3-4 seconds for the carbon fiber filament to reach the maximum electric power consumption (full watts). Also, there is a delay time of approximately 1.5-2.5 seconds until the temperature of the carbon fiber filament starts to rise from the room temperature after power is turned on. The delay time that it takes the general tungsten filament to start to rise above the room temperature after the power is turned on is approximately 0.6-0.8 seconds. Therefore, for using the carbon fiber filament as the heating source of the fusing apparatus, the carbon fiber filament is desirable to have the temperature rising performance substantially equal to the tungsten filament.

For this, the specific heat coefficient and weight of the tungsten filament that is used as the heat source of the fusing apparatus are measured to calculate the heat capacity of the tungsten filament. Then a carbon fiber filament has been developed to have the heat capacity near, equal to or smaller than the heat capacity of the tungsten filament. The heat capacity of the filament can be calculated by multiplication of the specific heat coefficient of the filament by the weight of the filament. In other words, the heat capacity of the filament=the specific heat coefficient of the filament×the weight of the filament

From the research results of the inventors it is found that decreasing the heat capacity of the carbon fiber filament allows temperature thereof to be rapidly increased so that the electric resistance thereof is rapidly decreased, the delay time thereof to be reduced, the temperature rising speed thereof to be improved, the heating efficiency thereof to be increased, the maximum temperature of the over-shoot thereof to be reduced, and the carbon fiber filament to quickly react with respect to the temperature control. Also, decreasing the heat capacity of the carbon fiber filament allows the temperature of the carbon fiber filament to rise so that the radiation heat flux of the carbon fiber filament is getting larger.

For using the carbon fiber filament as the heat source of the fusing apparatus, the carbon fiber filament 201 is desirable to have weight less than a predetermined value.

In other words, the weight of the carbon fiber filament 201 is determined by the linear density (or weight) and the number of the carbon fiber strands 201a consisting of the carbon fiber filament 201. Since the weight of the carbon fiber strand 201a is represented by the tex, the weight of the carbon fiber filament 201 may be said to be determined by the tex and the number of the carbon fiber strands 201a.

In order to develop a carbon fiber filament 201 usable in the fusing apparatus 100, a test measuring the properties of the carbon fiber filament 201 with changing the number of the carbon fiber strands and with maintaining constantly the tex of the carbon fiber strands 201a is performed. The results of the test are summarized in Table 2.

A fusing apparatus similar to the fusing apparatus illustrated in FIG. 2 is used for the test. Also, a control temperature of the carbon fiber lamp 200 is 185° C. and a duty control is −5° C.; 100%, −3° C.; 50%, −1° C.; 33%, 1° C.; 0%.

TABLE 2

| | | Outer | | | | | | |
|---|---|---|---|---|---|---|---|---|
| | | diameter | | Electric | | | | |
| | | of | Early | resistance | Specification of filament | | | |
| | | holding | electric | at full | Tex | | Inner | Number |
| | | pipe | resistance | power | Linear | strands | diameter | of |
| | filament | mm | Ω | Ω | density | pieces | mm | turns |
| 1Lamp | Tungsten | 6 | 5 | 60 | | | | |
| #0 | carbon | 8 | 73.6 | 39.7 | 40 | 9 | 4 | 64 |
| #1 | carbon | 10 | 69.6 | 38.2 | | 9 | 4 | 63 |
| #2 | carbon | 8 | 66.5 | 35.8 | | 7 | 4 | 64 |
| #3 | carbon | 8 | 72.7 | 39.3 | | 9 | 4 | 60 |
| #4 | carbon | 8 | 11 | 30.0 | | 9 | 4 | 64 |

| | | | When full power | | | | |
|---|---|---|---|---|---|---|---|
| | Actually | | | Temperature | | | |
| | measured | | temperature | rising | Energy | Time | |
| | full | | rising | efficiency | till | till | |
| | power | delay | speed | ° C./second/ | 180° C. | 180° C. | Over shoot |
| | Watts | second | ° C./second | 100 W | Whr | second | ° C. |
| 1Lamp | 765 | 0.8 | 21.8 | 2.85 | 2.00 | 8.6 | 203 |
| #0 | 1188 | 1.5 | 29.7 | 2.50 | 2.44 | 7.56 | 223 |
| #1 | 1235 | 1.2 | 32.3 | 2.62 | 2.32 | 6.65 | 226 |
| #2 | 1315 | 1.2 | 35.8 | 2.72 | 2.23 | 6.23 | 230 |
| #3 | 1240 | 1.2 | 31.7 | 2.56 | 2.32 | 6.74 | 224 |
| #4 | 1577 | 1.3 | 38.6 | 2.44 | 2.70 | 6.12 | 245 |

Referring to Table 2, decreasing the number of the carbon fiber strands 201a from nine strands to seven strands allows the temperature rising efficiency to become better. In other words, due to the decreasing of the weight of the filament the temperature of the carbon fiber filament 201 rises quickly and becomes higher so that the radiation heat flux of the lamp to heat the heat member for fusing increases. In other words, if the weight (heat capacity) of the carbon fiber filament 201 is decreased, smaller energy is consumed to increase the temperature of the filament itself. As a result, the carbon fiber filament 201 is increased to higher temperature so as to increase the energy that is radiated as radiation heat.

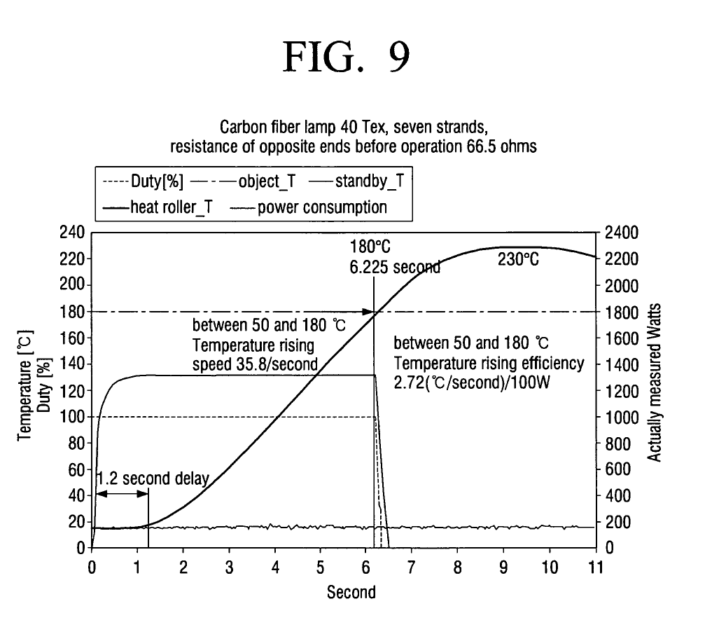

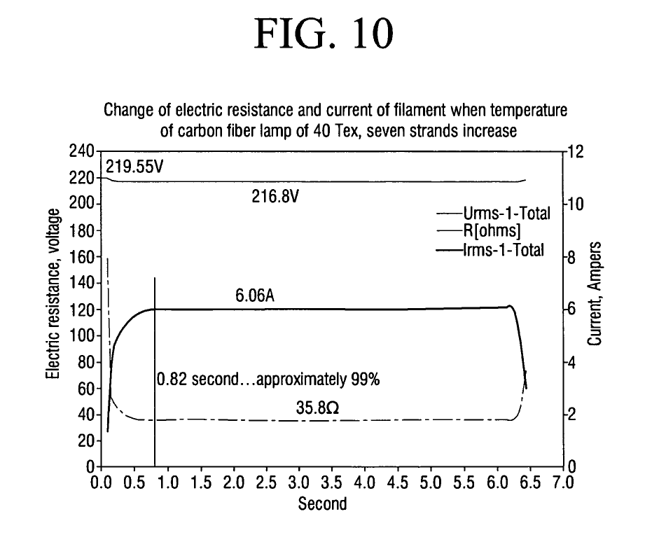

FIGS. 9 and 10 illustrate a graph of temperature rising speed and electric power consumption and a graph of current-electric resistance-voltage according to time of the heat roller 121 in which the carbon fiber filament 201 formed of seven 40 tex carbon fiber strands 201a is disposed. The carbon fiber filament lamp 200 is for 200-250 V. The electric resistance between opposite terminals of the carbon fiber filament 201 is approximately 55-85Ω. At this time, the carbon fiber filament 201 having the electric resistance between opposite terminals of the range of 5-100Ω, can be used. If the carbon fiber filament 201 is used in the range of 90-130 V, the carbon fiber filament 201 having the electric resistance between opposite terminals of the range of 2-50Ω can be used. Referring to FIGS. 9 and 10, when the power switch is turned on, the temperature of the carbon fiber filament 201 is increased so that the electric resistance thereof is reduced and heating quantity is increased. The carbon fiber filament 201 exposes negative resistance property as a semiconductor according to temperature. In the graph of temperature rising-electric power consumption graph of FIG. 9, there is a delay time until the temperature is increased at early part. According as the temperature rises up, the electric resistance is decreased and the current flowing into the carbon fiber filament 201 is increased so that the heat quantity is increased. In FIG. 9, the duty represents a duty signal that a control portion (not illustrated) of the fusing apparatus 100 sends to the heat roller 121.

Table 3 shows results of temperature rising test with respect to carbon fiber filaments 201 made of carbon fiber strands of 35 tex and 40 tex.

TABLE 3

| | | | | | Specification | | Specification | | Specification | | Specification | |
|---|---|---|---|---|---|---|---|---|---|---|---|---|
| | specification | unit | | tungsten | #1 | | #2 | | #3 | | #4 | |
| | Tex | | Linear | | 35 | 35 | 35 | 35 | 40 | 40 | 40 | 40 |
| | | | density | | | | | | | | | |
| | Strands | | | | 7 | 7 | 7 | 7 | 7 | 7 | 7 | 7 |
| | Pitch | | Number of | | 58 | 58 | 58 | 58 | 64 | 64 | 64 | 64 |
| | | | turns | | | | | | | | | |
| | Electric | ohm | | 6 | 72 | 72 | 63 | 63 | 72 | 72 | 67 | 67 |
| | resistance at | | | | | | | | | | | |
| | opposite ends | | | | | | | | | | | |
| | Supply V when | | | 218 | 220 | 220 | 220 | 220 | 220 | 220 | 220 | 220 |
| | testing | | | | | | | | | | | |
| | Number of test | | | | first | second | First | second | first | second | first | second |
| Data | Maximum | W | | 771 | 1242 | 1248 | 1348 | 1347 | 1239 | 1245 | 1328 | 1332 |
| | power | | | | | | | | | | | |
| | Time till | Second | | 8.81 | 6.71 | 6.60 | 6.40 | 6.30 | 7.41 | 7.3 | 6.80 | 6.68 |
| | temperature | | | | | | | | | | | |
| | reach from 18° C. | | | | | | | | | | | |
| | to 180° C. | | | | | | | | | | | |
| result | temperature | □/second | Including | 2.65 | 2.16 | 2.19 | 2.09 | 2.12 | 1.96 | 1.98 | 1.99 | 2.02 |
| | rising speed | | early | | | | | | | | | |
| | per 100 W | | delay time | | | | | | | | | |
| | temperature | % | Including | 100 | 82 | 82 | 79 | 80 | 74 | 75 | 75 | 76 |
| | rising speed | | early | | | | | | | | | |
| | per 100 W | | delay time | | | | | | | | | |
| | Energy | Whr | From start | 1.94 | 2.26 | 2.25 | 2.34 | 2.30 | 2.46 | 2.45 | 2.43 | 2.44 |
| | consumption | | to 180° C. | | | | | | | | | |
| | Energy | % | Compared | 100 | 116 | 116 | 121 | 119 | 127 | 126 | 125 | 126 |
| | consumption | | with | | | | | | | | | |
| | | | tungsten | | | | | | | | | |

Here, the temperature rising speed is calculated in a time range from when a power switch of the lamp is turned on to when the lamp reach the fusing temperature of 180° C.

In Table 3 it is found that 35 tex carbon fiber filament has the temperature rising speed faster and the heating efficiency better than 40 tex carbon fiber filament. For example, the energy that the 35 tex carbon fiber filaments of specification #1 and #2 had consumed until the temperature of the heat roller reaches 180° C. is smaller than that of 40 tex carbon fiber filaments of specification #3 and #4 so that the 35 tex carbon fiber filament has an efficiency better than the 45 tex carbon fiber filament.

The changes of the temperature rising speed and the heating efficiency according to reducing the number of the carbon fiber strands of the carbon fiber filament are tested. The test results are summarized in Table 4. Table 4 is the test result with respect to a lamp having the carbon fiber filament 201 configured of five 35 tex carbon fiber strands 201a.

TABLE 4

| | Specification | unit | Tungsten 1 | Tungsten 2 | #5 | |
|---|---|---|---|---|---|---|
| | Tex | | | | 35 | 35 |
| | Strands | | | | 5 | 5 |
| | Pitch | | | | 60 | 60 |
| | Electric resistance | ohm | | | 68 | 68 |
| | at opposite ends | | | | | |
| | Number of test | | | | first | second |
| | Lamp type | | single | dual | single | Single |
| | Lamp supply | Volts | 220.54 | 220.54 | 220.32 | 220.32 |
| | voltage | | (wall current) | (wall current) | (AC source) | (AC source) |
| Data | Maximum | W | 778 | 1189 | 1290 | 1292 |
| | consumption power | | | | | |
| | Time till | Second | 8.11 | 5.49 | 5.55 | 5.60 |
| | temperature reach | | | | | |
| | from start to 180 □ | | | | | |
| | Delay time | Second | 0.74 | 0.65 | 0.88 | 0.83 |
| | (standby + 3□ reach) | | | | | |
| Inrush | Peak current | A | 40.60 | 46.7 | 7.32 | 6.76 |
| | (switch ON) | | | | | |
| | Inrush power | W | 2402.0 | 5280.0 | 972.0 | 836.0 |
| | (switch ON) | | | | | |
| Result | temperature rising | □/second | 2.58 | 2.50 | 2.28 | 2.25 |
| | speed per 100 W | | | | | |
| | temperature rising | % | 100 | 97 | 88 | 87 |
| | speed per 100 W | | | | | |
| | Energy | Whr | 1.82 | 1.89 | 2.01 | 2.00 |
| | consumption | | | | | |
| | Energy | % | 100 | 104 | 110 | 110 |
| | consumption | | | | | |

Here, the temperature rising speed is calculated in a time range from when a power switch of the lamp 200 is turned on to when the lamp reach the fusing temperature of 180° C.

In Tables 3 and 4, when the number of 35 tex carbon fiber strands is reduced from seven to five, the temperature rising speed rises approximately 8-9% and the heating efficiency rises approximately 10%. That is, the energy consumption until the temperature of the heat roller reaches 180° C. is reduced approximately 10%.

Improvements in the temperature rising speed and in the heating efficiency are achieved by reducing the heat capacity of the carbon fiber filament 201 by nearly the heat capacity of the tungsten filament.

The heat member, such as the heat roller 121, a heat belt or the like, for heating unfused developer is mainly heated by radiation energy from the lamp 200. The radiation heat flux is increased in proportion to the fourth power of the temperature of the heat source as a below formula.

q=σ T⁴A

Here, q is heat transfer per unit time (W), a is 5.6703×10-8 (W/m²K⁴) as Stefan-Boltzmann constant, T is absolute temperature (K), and A is an area of a heat body (m²).

Therefore, for increasing the temperature rising speed of the heat member, the temperature of the carbon fiber filament 201 needs to be increased. For increasing the temperature of the carbon fiber filament 201, the heat capacity of the carbon fiber filament 201 is desirable to be reduced.

Table 5 shows measuring results of temperature change of the carbon fiber filament according to change of the tex and the number of the carbon fiber strands 201a. At this time, the specific heat coefficient of the used carbon fiber filament 201 is 1610 J/Kg ° C. The weight of the filament is determined based on the carbon fiber filament 201 that is used in the fusing apparatus 100 that can fuse A4 paper having the width of 218 mm.

TABLE 5

| | | | Total heat | Actually | Temperature |
|---|---|---|---|---|---|
| | | Total weight | capacity of | measured | in thermal |
| | Number | of heat part | heat part of | maximum | steady-state |
| | of | of filament | filament | power | of filament |
| Tex | strands | (g) | (J/□) | consumption | (□) |
| 35 | 5 | 0.252 | 0.406 | 1290 | 2220 |
| 40 | 7 | 0.339 | 0.546 | 1250 | 1825 |
| 40 | 9 | 0.361 | 0.581 | 1240 | 1780 |
| 70 | 7 | 0.861 | 1.386 | 1180 | 1510 |
| 70 | 9 | 0.950 | 1.530 | 1150 | 1390 |
| 100 | 9 | 1.269 | 2.043 | 1125 | 1200 |

From above explanation, it is found that reduction of the heat capacity of the carbon fiber filament allows the temperature rising speed and heat efficiency thereof to be increased, the delay time thereof to be decreased, and high temperature thereof to be controlled. So the carbon fiber filament can be used as the heat source.

However, if the carbon fiber filament has a large heat capacity, to replace the a conventional tungsten lamp of 230 V, 850 W with the carbon fiber filament lamp 200 has no advantage due to the delay time and heat efficiency.

In Table 5, the carbon fiber filament 201 having a specification in which the temperature in thermal steady-state of filament is 1510° C. or more can be used as the fusing heat source. However, the carbon fiber filaments 201 below the specification are not proper for the fusing heat source. In other words, the carbon fiber filament having the heat capacity of approximately 1.4 J/° C. or less can be used as the fusing heat source. The minimum value of the heat capacity of the carbon fiber filament depends on how small is the tex of the carbon fiber strands constituting the carbon fiber filament. The carbon fiber filament can be substantially made to have heat capacity of approximately 0.1 J/° C.

Weight per unit lamp length of the carbon fiber filament can be calculated from the above described test results. Since the above tests are performed using the fusing apparatus that can fuse A4 paper of 218 mm, the length of the lamp can be said to be 218 mm. As a result, the weight per unit lamp length of the carbon fiber filament is 0.86 g/218 mm=0.4 mg/mm. Therefore, the carbon fiber filament having the weight per unit lamp length of 0.4 mg/mm or less can be used as the heat source of the fusing apparatus. The minimum value of the weight per unit lamp length of the carbon fiber filament can be determined according to the minimum value of the heat capacity of the carbon fiber filament.

From the above test results, it is desirable that the carbon fiber filament 201 is made of carbon fiber strands 201a of which linear density is 70 tex or less and of which the number is seven or less in order to use the carbon fiber filament 201 as the fusing heat source. When the linear density of the carbon fiber strands 201a is 40 tex, the carbon fiber filament 201 can be made of nine carbon fiber strands. The minimum value of the linear density of the carbon fiber strand is determined by manufacturing limit of the carbon fiber strands. Therefore, the minimum value of the linear density of the carbon fiber strands 201a may be 1 tex.

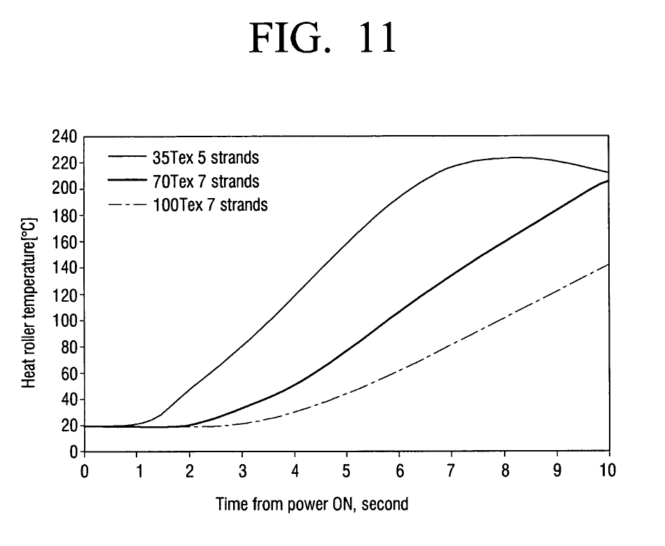

FIG. 11 is a graph illustrating temperature change according to time from when electric power is turned on with respect to three type carbon fiber filaments. Here, the three type carbon fiber filaments are formed of five 35 tex carbon fiber strands, seven 70 tex carbon fiber strands and seven 100 tex carbon fiber strands, respectively.

In FIG. 11, when the heat capacity of the carbon fiber filament is decreased, the temperature rising speed and the heat efficiency are increased. Also, since the smaller the heat capacity is the faster the temperature rises, the electric resistance is quickly lowered and inflow of electric charge is rapidly increased so that the time when the temperature starts to rise becomes earlier.

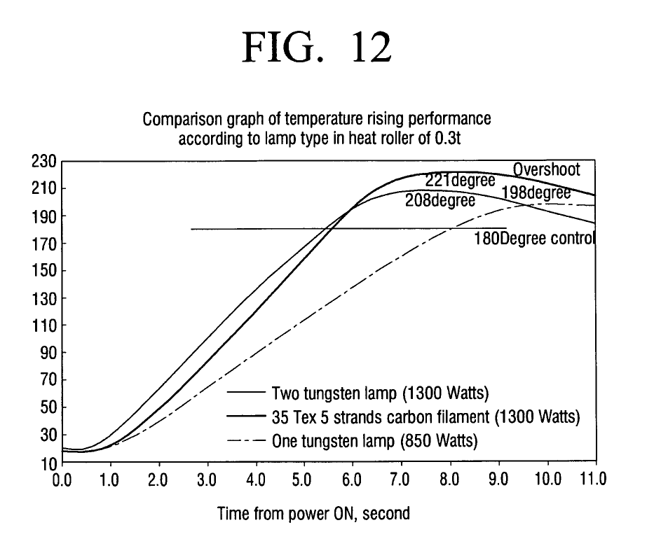

Next, for comparing the performance of the lamp using the carbon fiber filament according to an embodiment with the performance of the conventional lamp using the tungsten filament, inventors made a carbon fiber filament lamp using a carbon fiber filament with the same heat capacity as that of the tungsten filament and performed the comparison test. Results of the comparison test are illustrated in FIG. 12 and specifications of the used carbon fiber filament and tungsten filament are summarized in Table 6. The heat roller 121 used in the test has a width that can fuse A4 paper having a width of 218 mm and the thickness of the heat roller 121 is 0.3 mm.

TABLE 6

| | | 230 V-1300 W | 230 V-1300 W |
|---|---|---|---|
| | unit | tungsten filament | carbon fiber filament |
| Specific heat | J/Kg□ | 134 | 1610 |
| coefficient | | | |
| Weight of filament | g | 2.600 | 0.216 |
| Heat capacity of | J/□ | 0.3484 | 0.3484 |
| filament | | | |

Referring to FIG. 12, the conventional carbon fiber filament is behind the tungsten filament in performance. However, in the carbon fiber filament according to an embodiment, the delay time is improved to be 0.8 seconds, and the time to reach 180° C. is the same as that of the dual tungsten lamp using two 1300 W tungsten filaments.

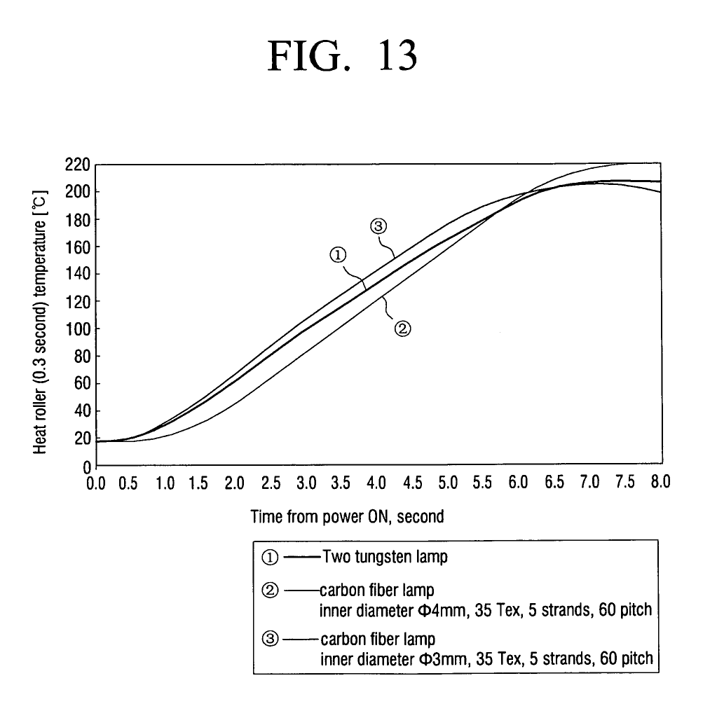

FIG. 13 is a graph illustrating temperature change according to time of carbon fiber filaments 201 which are coiled in a spiral shape, have the same pitch p as that of the carbon fiber filament in FIG. 4 and have inner diameters of 3 mm and 4 mm. Referring to FIG. 13, since 3 mm carbon fiber filament has weight of 0.195 g and is lighter than the 4 mm carbon fiber filament, the temperature rising speed and the heat efficiency are increased by approximately 4% and the delay time until temperature starts to rise is also reduced by approximately 0.04 seconds as compared to the dual tungsten lamp.

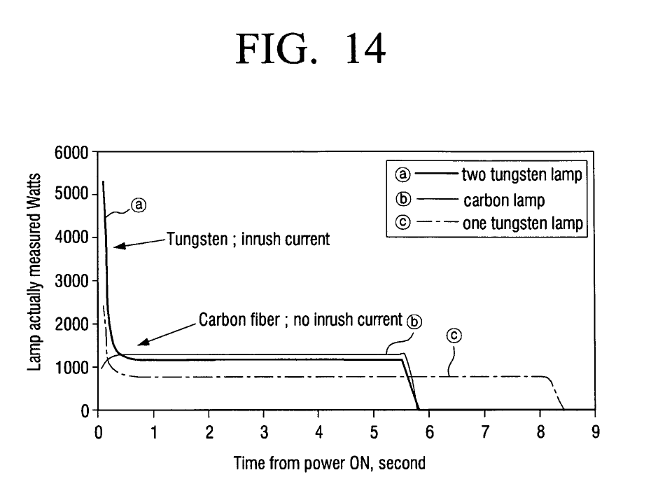

The fusing apparatus 100 using the carbon fiber filament according to an embodiment has no inrush current as illustrated in FIG. 14 so that the flicker phenomenon does not occur. Therefore, the fusing apparatus can reduce FPOT and can be used in high speed printing apparatuses. Also, the control of the fusing apparatus is simpler than that of the conventional fusing apparatus using the tungsten lamp and manufacturing cost thereof can be reduced.

While the embodiments of the present disclosure have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the present disclosure.

What is claimed is:

1. A heater for a fusing apparatus that is used in an image forming apparatus, the heater comprising:
a carbon fiber filament;
a holding pipe which receives the carbon fiber filament; and
terminals which are disposed opposite ends of the holding pipe and connects the carbon fiber strands with an electric power source;
wherein the carbon fiber filament is formed of any of one to seven carbon fiber strands and each of the carbon fiber strands has linear density of any of 1-70 tex.

2. The heater of claim 1, wherein the carbon fiber filament is formed of the carbon fiber strand of any of 20-40 tex.

3. The heater of claim 1, wherein the carbon fiber strand is composed of 1100 or less carbon fiber yarns.

4. The heater of claim 1, wherein the heater has an output of 700 W-3000 W, and the carbon fiber filament has weight of 0.86 g or less.

5. The heater of claim 4, wherein the carbon fiber filament has weight per unit length of 4 mg/mm or less.

6. The heater of claim 1, wherein the carbon fiber filament comprises metal contents and carbon content of 50% or more.

7. The heater of claim 1, wherein the carbon fiber filament is formed in a spiral shape, and the spiral has an inner diameter of 8 mm or less.

8. The heater of claim 1, wherein the carbon fiber filament comprises heat capacity of 1.4 J/° C. or less.

9. The heater of claim 1, wherein the holding pipe has an inner diameter of 10 mm or less and a thickness of 1.0 mm or less.

10. The heater of claim 1, wherein the holding pipe has an outer diameter of 10 mm or less.

11. The heater of claim 3, wherein the carbon fiber yarn includes metal contents and carbon content of 50% or more.

12. A heater for a fusing apparatus that is used in an image forming apparatus, the heater comprising:
a carbon fiber filament;
a holding pipe which receives the carbon fiber filament; and
terminals which are disposed opposite ends of the holding pipe and connects the carbon fiber strands with an electric power source;
wherein the carbon fiber filament is formed of any of 1-70 tex carbon fiber strands, and wherein when rated voltage applying to the carbon fiber filament is in a range of 200-250 V, electric resistance of opposite ends of the carbon fiber filament is in a range of 5-100Ω.

13. The heater of claim 12, wherein when electric power is supplied to the carbon fiber filament, a maximum temperature of the carbon fiber filament is 1500° C. or more.

14. A heater for a fusing apparatus that is used in an image forming apparatus, the heater comprising:
a carbon fiber filament;
a holding pipe which receives the carbon fiber filament; and
terminals which are disposed opposite ends of the holding pipe and connects the carbon fiber strands with an electric power source;
wherein the carbon fiber filament is formed of any of 1-70 tex carbon fiber strands, and wherein when rated voltage applying to the carbon fiber filament is in a range of 90-130 V, electric resistance of opposite ends of the carbon fiber filament is in a range of 2-50Ω.

15. The heater of claim 14, wherein when electric power is supplied to the carbon fiber filament, a maximum temperature of the carbon fiber filament is 1500° C. or more.

16. A fusing apparatus comprising:
a heater, the heater comprising
a carbon fiber filament;
a holding pipe which receives the carbon fiber filament; and
terminals which are disposed opposite ends of the holding pipe and connects the carbon fiber strands with an electric power source;
wherein the carbon fiber filament is formed of any of one to seven carbon fiber strands and each of the carbon fiber strands has linear density of any of 1-70 tex.

17. An image forming apparatus comprising:
a fusing apparatus comprising a heater, the heater comprising
a carbon fiber filament;
a holding pipe which receives the carbon fiber filament; and
terminals which are disposed opposite ends of the holding pipe and connects the carbon fiber strands with an electric power source;
wherein the carbon fiber filament is formed of any of one to seven carbon fiber strands and each of the carbon fiber strands has linear density of any of 1-70 tex.
